(19) United States
(12) Patent Application Publication
(10) Pub. No.: US 2016/0144502 A1
(43) Pub. Date: May 26, 2016

(54) Toolbox

(71) Applicant: James Perkins, Sudan, NM (US)

(72) Inventor: James Perkins, Sudan, NM (US)

(21) Appl. No.: 14/951,486

(22) Filed: Nov. 24, 2015

Related U.S. Application Data
(60) Provisional application No. 62/083,388, filed on Nov. 24, 2014.

(51) Int. Cl. B25H 3/02; B25H 3/04

(52) U.S. Cl. CPC B25H 3/028; B25H 3/04

(57) ABSTRACT

A toolbox is disclosed. The toolbox comprises a body, a one or more supports and a pivoting rack. The body comprises a lid, a bottom plate, a faceplate, a back plate, a first side, a second side. The toolbox is configured for selectively transitioning between an expanded configuration and a closed configuration. The expanded configuration of the toolbox comprises an expanded height. The body selectively opens and closes between the expanded configuration and the closed configuration. With the toolbox in the closed configuration the body comprises a substantially rectangular shape and encases the tool box with the first side and the second side on it sides, the lid and a bottom plate at its top and bottom, and the faceplate and a back plate at its front and back sides. The lid selectively rotates on a first hinge relative to the back plate. The faceplate selectively rotates on a second hinge relative to the lid rack. With the toolbox in the expanded configuration, the one or more supports a portion of the toolbox. With the toolbox in the closed configuration the faceplate selectively rotates on the second hinge to provide access within the toolbox. A portion of the body wraps around the pivoting rack including the bottom plate which is attached to the back plate, the lid which is rotateably attached to the back plate, and the faceplate which is rotateably attached to the lid.

### CROSS-REFERENCE TO RELATED APPLICATIONS

This application claims benefit to U.S. Patent Application No. 62/083,388, filed Nov. 24, 2014 which was one year prior to the filing of this application. All rights in the earlier application are claimed and incorporated by reference hereby.

### PETITION TO MAKE SPECIAL

Submitted herewith is USPTO form PTO/SB/130 (07-09) establishing the Applicant's entitlement to make this application special based on the age of the Applicant.

### STATEMENT REGARDING FEDERALLY SPONSORED RESEARCH OR DEVELOPMENT (IF APPLICABLE)

Not applicable.

Not applicable.

### BACKGROUND OF THE INVENTION

This disclosure relates generally to an improved toolbox. Examples of similar disclosures can be found at U.S. Pat. No. 7,510,078 B2. However, none of the known inventions and patents, taken either singularly or in combination, is seen to describe the instant disclosure as claimed. Accordingly, an improved toolbox would be advantageous.

### BRIEF SUMMARY OF THE INVENTION

A toolbox is disclosed. The toolbox comprises a body, a one or more supports and a pivoting rack. The body comprises a lid, a bottom plate, a faceplate, a back plate, a first side, a second side. The toolbox is configured for selectively transitioning between an expanded configuration and a closed configuration. The expanded configuration of the toolbox comprises an expanded height. The body selectively opens and closes between the expanded configuration and the closed configuration. With the toolbox in the closed configuration the body comprises a substantially rectangular shape and encases the tool box with the first side and the second side on it sides, the lid and a bottom plate at its top and bottom, and the faceplate and a back plate at its front and back sides. The lid selectively rotates on a first hinge relative to the back plate. The faceplate selectively rotates on a second hinge relative to the lid rack. With the toolbox in the expanded configuration, the one or more supports a portion of the toolbox. With the toolbox in the closed configuration the faceplate selectively rotates on the second hinge to provide access within the toolbox. A portion of the body wraps around the pivoting rack including the bottom plate which is attached to the back plate, the lid which is rotateably attached to the back plate, and the faceplate which is rotateably attached to the lid.

### BRIEF DESCRIPTION OF THE SEVERAL VIEWS OF THE DRAWING

FIGS. 1A and 1B illustrate an elevated first side and second side overview of a toolbox 100 in an expanded configuration 101.

FIG. 2 illustrates an elevated front side view of said toolbox 100 in said expanded configuration 101.

FIG. 3 illustrates an elevated front side view of said toolbox 100 in a closed configuration 300 with said faceplate 106 opened.

FIG. 4 illustrates an elevated second side overview of said toolbox 100 in a closed configuration 300 with said faceplate 106 closed.

FIG. 5 illustrates an elevated front side view of said toolbox 100 in said expanded configuration 101 with a one or more tools.

FIG. 6 illustrates an elevated second side overview of said toolbox 100 in an expanded configuration 101 being partially disassembled without said second side 108b and with said drawer 114 removed.

FIG. 7 illustrates an elevated second side overview of said drawer 114.

FIGS. 8A and 8B illustrate an elevated first side cross-section view of said toolbox 100 in said closed configuration 300, first as a perspective overview and then as an elevated side view, respectively.

FIGS. 9A, 9B, 9C and 9D illustrate for annotated versions of an elevated first side cross-section view of said toolbox 100 in said a first position 902.

FIG. 10 illustrates an elevated front view said toolbox 100 in said second position 904.

FIG. 11 illustrates a perspective overview of said toolbox 100 in said second position 904.

### DETAILED DESCRIPTION OF THE INVENTION

Described herein is an improved toolbox. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system-and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

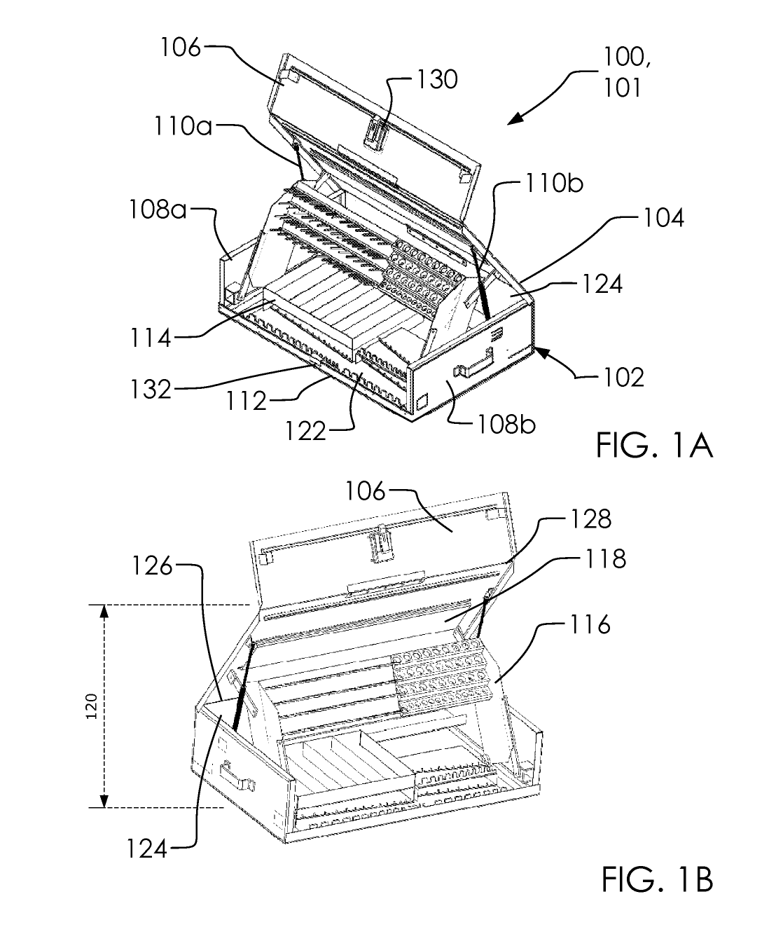

FIGS. 1A and 1B illustrate an elevated first sidend second side overview of a toolbox 100 in an expanded configuration 101.

In one embodiment, said toolbox 100 can comprise a body 102, a lid 104, a faceplate 106, a sides (which can comprise a first side 108a and a second side 108b), a one or more supports (which can comprise a first support 110a and a second support 110b), a lower tray 112, a drawer 114, a pivoting rack 116, and a lid rack 118. In one embodiment, said expanded configuration of said toolbox 100 can comprise an expanded height 120. In one embodiment, said body 102 can encase said toolbox 100 with: said first side 108a and said second side 108b on it sides; said lid 104 and a bottom plate 122 at its top and bottom; and said faceplate 106 and a back plate 124 at its front and back sides. In one embodiment, said lid rack 118 rotates on a first hinge 126 relative to said back plate 124; and said faceplate 106 rotates on a second hinge 128 relative to said lid rack 118.

In one embodiment, said toolbox 100 can comprise a latching system which can comprise a latch 130 and a strike plate 132; further, said latching system can comprise a locking mechanism as is known in the art.

In one embodiment, said lid 104 and said faceplate 106 can be held up by said first support 110a and said second support 110b.

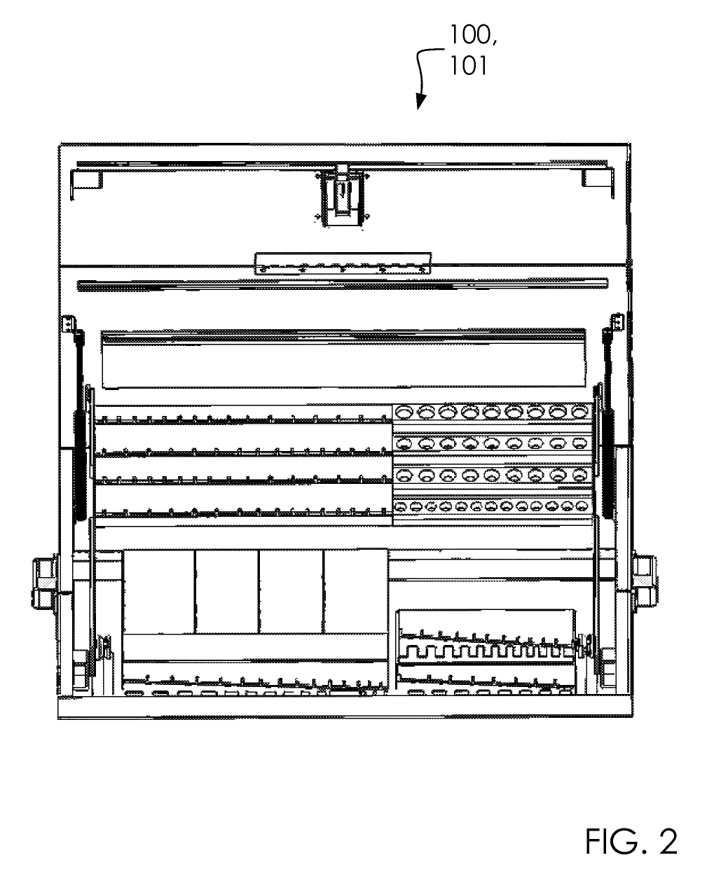

FIG. 2 illustrates an elevated front side view of said toolbox 100 in said expanded configuration 101.

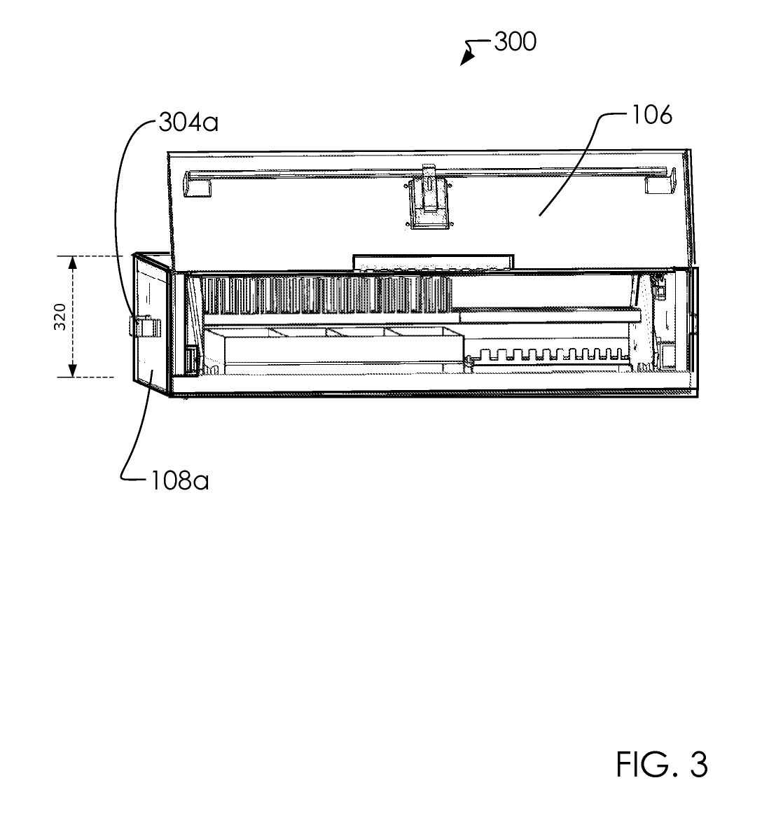

FIG. 3 illustrates an elevated front side view of said toolbox 100 in a closed configuration 300 with said faceplate 106 opened.

In one embodiment, said first side 108a can comprise a first handle 304a on said first side 108a, and a second handle 304b (not illustrated here) on said second side 108b. In one embodiment, said toolbox 100 can comprise a one or more handles (which can comprise said first side 108a and said second side 108b).

In one embodiment, said collapsed configuration 300 can allow for access to tools within said toolbox 100. For example, in one embodiment, said faceplate 106 can open with said toolbox 100 in said collapsed configuration 300; thereby, said drawer 114 (for example) can be rolled out and accessed with said toolbox 100 in a low profile (that is, said collapsed configuration 300). This feature can be a substantial value add to users of said toolbox 100, because they can stack tools and equipment on top of said toolbox 100 and still access a portion of its contents. Further, said toolbox 100 can be constructed to withstand heavy weights on top of said lid 104. The combination of these features amounts to a more useful tool box than the prior art because it is compact and still accessible, but none the less can fold up and expose a complete tool set when desired.

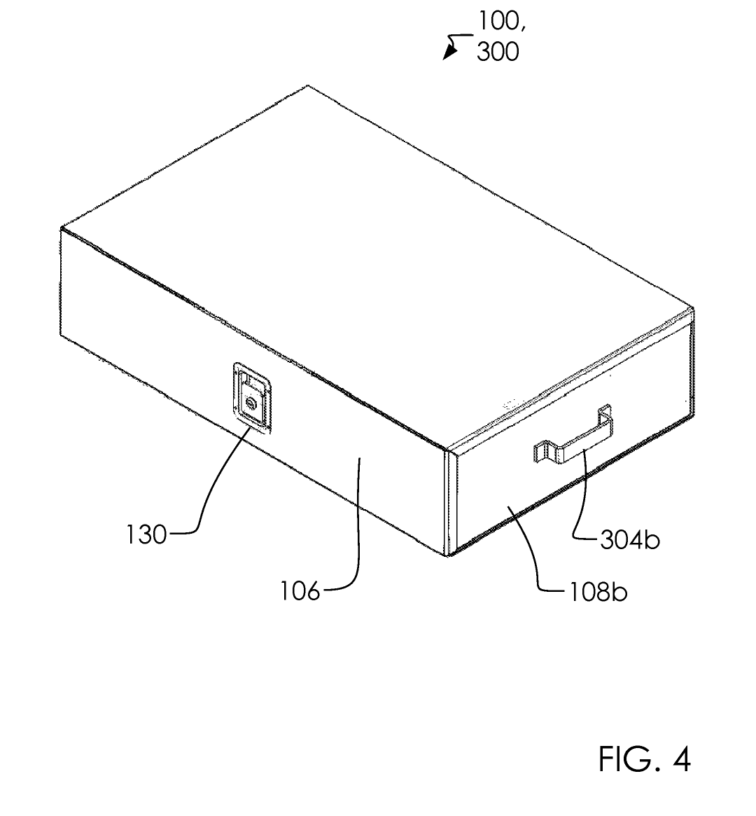

FIG. 4 illustrates an elevated second side overview of said toolbox 100 in a closed configuration 300 with said faceplate 106 closed.

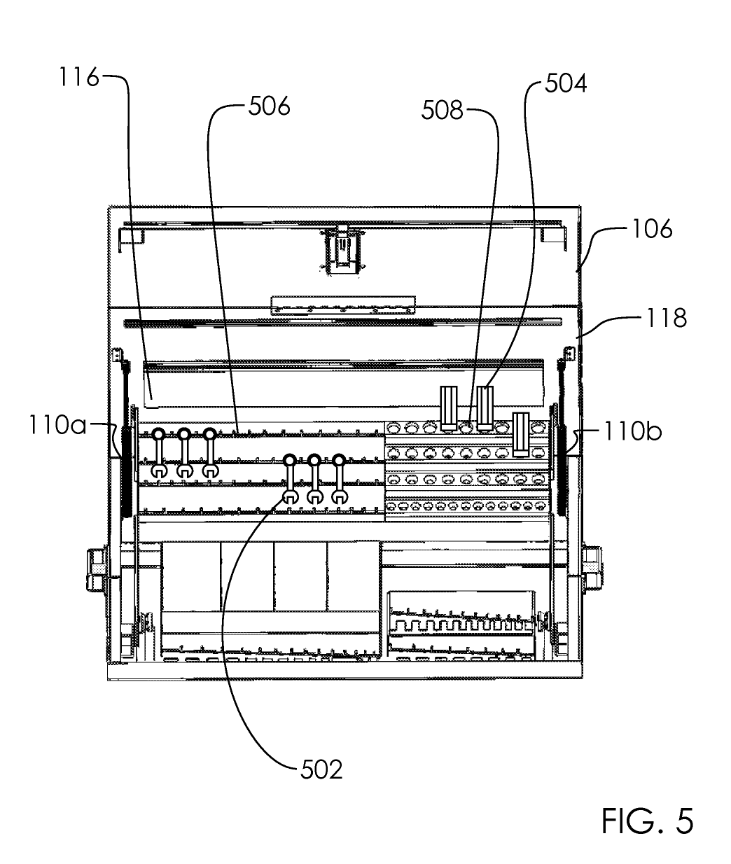

FIG. 5 illustrates an elevated front side view of said toolbox 100 in said expanded configuration 101 with a one or more tools.

In one embodiment, said one or more tools can comprise a wrench 502, a screwdriver 504. In one embodiment, said pivoting rack 116 can comprise a one or more pegs 506 which can hold said wrench 502; and a one or more slots 508 which can hold said screwdriver 504.

In one embodiment, said first support 110a and said second support 110b can support said faceplate 106 and said lid 104 when said toolbox 100 is in said expanded configuration 101 and/or said closed configuration 300. In one embodiment, said first side first side 108a and said second side 108b can comprise pneumatic cylinders.

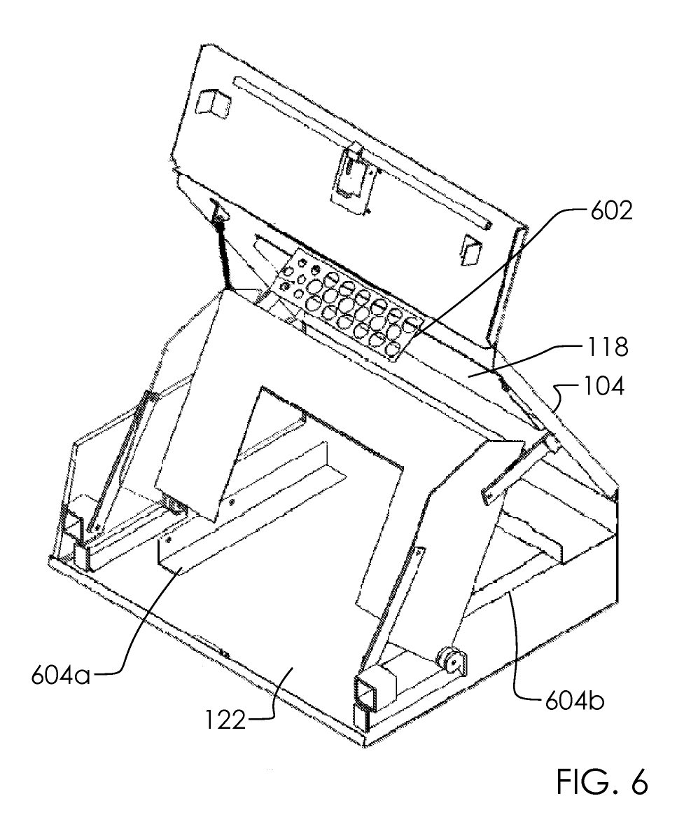

FIG. 6 illustrates an elevated second side overview of said toolbox 100 in an expanded configuration 101 being partially disassembled without said second side 108b and with said drawer 114 removed.

In one embodiment, said lid 104 can comprise a one or more tool slots 602, capable of holding one or more tools such as said screwdriver 504. In one embodiment, said bottom plate 122 of said toolbox 100 can comprise a one or more tracks which can comprise a first track 604a and a second track 604b. In one embodiment, said one or more tracks can be arranged as perpendicular with said faceplate 106 with said toolbox 100 in said closed configuration 300. In one embodiment, said drawer 114 can ride on said one or more tracks, as is known in the art.

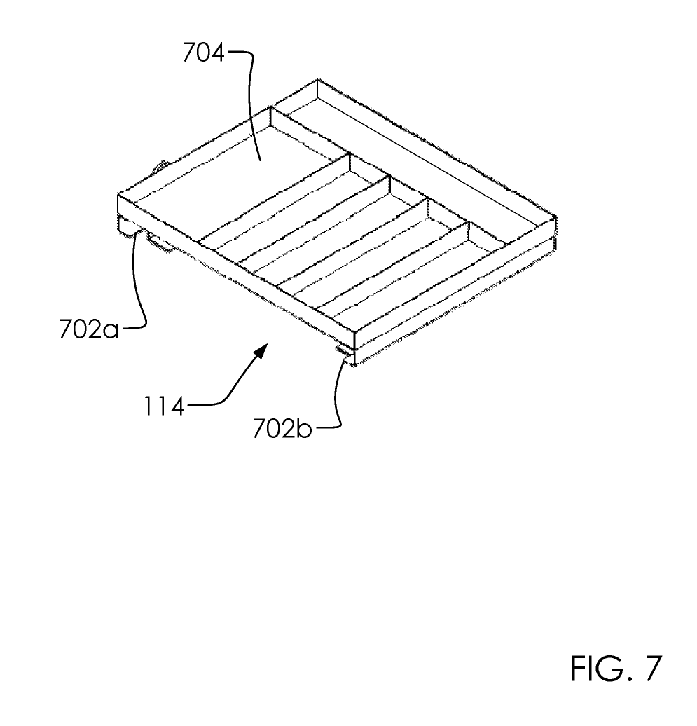

FIG. 7 illustrates an elevated second side overview of said drawer 114.

In one embodiment, said drawer 114 can comprise a one or more runners which can comprise a first runner 702a and a second runner 702b. In one embodiment, said one or more runners can releaseably attach to said one or more tracks; wherein, said drawer 114 can move relative to said bottom plate 122 on said one or more tracks. In one embodiment, said one or more runners can comprise bearings, wheels, or a friction surface allowing said drawer 114 to slide there along. In one embodiment, said drawer 114 can comprise a one or more compartments, such as a compartment 704.

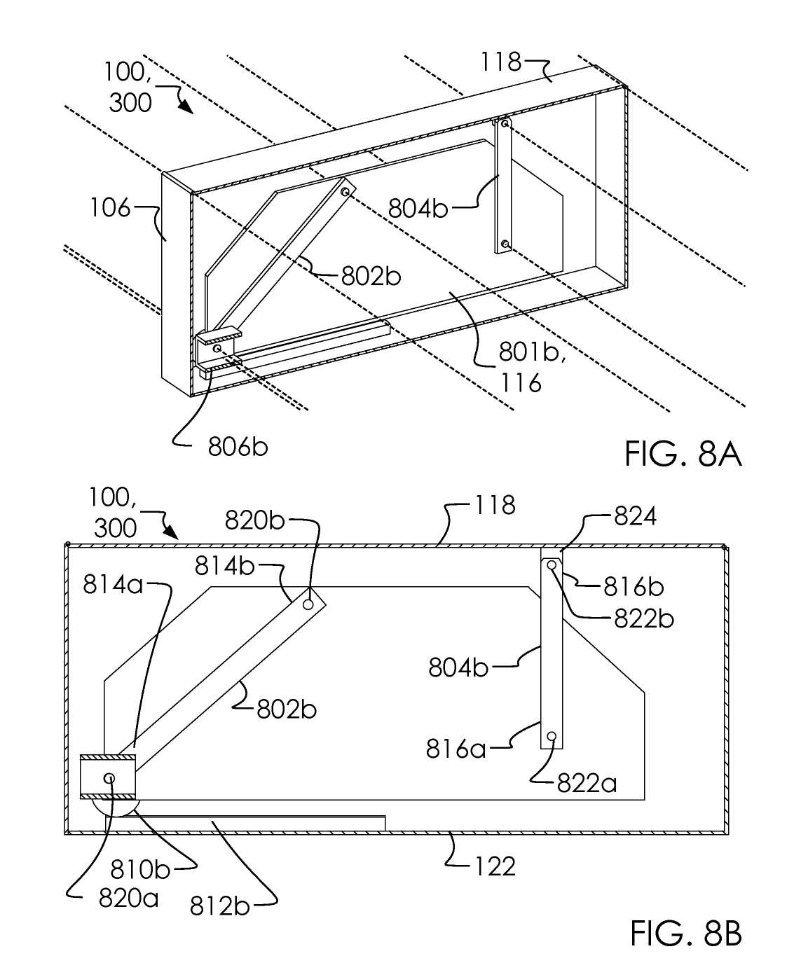

FIGS. 8A and 8B illustrate an elevated first side cross-section view of said toolbox 100 in said closed configuration 300, first as a perspective overview and then as an elevated side view, respectively.

In one embodiment, said pivoting rack 116 can comprise a first side portion 801a (not illustrated) and a second side portion 801b. In one embodiment, said second side portion 801b can comprise a substantially vertical planar surface attached to said body 102 with a first support 802b and said lid 104 with a second support 804b, as discussed to follow. Likewise, said first side portion 801a can be attached to said lid 104 with a second support 804a and said body 102 with a first support 802a (not illustrated).

In one embodiment, said toolbox 100 can further comprise a one or more outer supports which can comprise an outer support 806a (not illustrated) and an outer support 806b. In one embodiment, said one or more outer supports can attach to said pivoting rack 116 to said first side 108a and said second side 108b.

In one embodiment, said first support 802b can comprise a first end 814a and a second end 814b. In one embodiment, said first end 814a can rotateably attach to said outer support 806b with a first hinge 820a. In one embodiment, said second end 814b can rotateably attach to said second side portion 801b with a second hinge 820b. In one embodiment, said second support 804b can comprise a first end 816a and a second end 816b. In one embodiment, said first end 816a can rotateably attach to said second side portion 801b with a first hinge 822a. In one embodiment, said lid 104 can comprise a lid support 824, which can comprise a substantially vertical element suspended from and attached to said lid 104 being substantially parallel with said second support 804b. In one embodiment, said second end 816b can rotateably attach to said lid support 824 of said lid 104 with a second hinge 822b.

In one embodiment, said pivoting rack 116 can move horizontally on a one or more side tracks on said bottom plate 122, which can comprise a first side track 812a (not illustrated) and a second side track 812b. In one embodiment, said pivoting rack 116 can comprise a one or more side wheels, which can comprise a first side wheel 810a (not illustrated) and a second side wheel 810b. In one embodiment, said first side wheel 810a can roll on said first side track 812a, and said second side wheel 810b can roll on said second side track 812b. In one embodiment, said first side wheel 810a and said second side wheel 810b can roll on said one or more side tracks, as illustrated and as is known in the art.

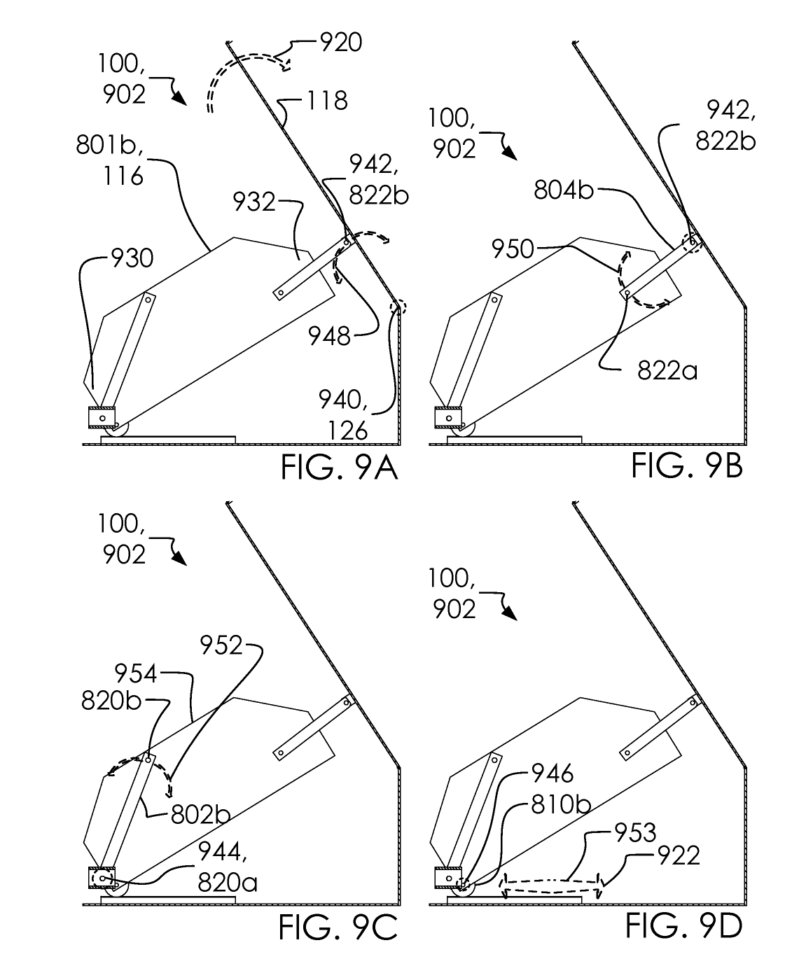

FIGS. 9A, 9B, 9C and 9D illustrate for annotated versions of an elevated first side cross-section view of said toolbox 100 in said a first position 902.

In one embodiment, said first position 902 and a second position 904 (not illustrated here) can comprise two configurations of said toolbox 100 in transition from said closed configuration 300 to said expanded configuration 101.

In one embodiment, said pivoting rack 116 can move according to a four axes comprising a first axis 940, a second axis 942, a third axis 944 a fourth axis 946. In one embodiment, said first axis 940 can comprise said first hinge 126 and can comprise an axis about which said second hinge 822b rotates. Thus, by lifting said lid rack 118 in said upward direction 920, said second hinge 822b can rotate about said first axis 940 in a first path 948.

In one embodiment, said second axis 942 can comprise said second hinge 822b and can comprise an axis about which said first hinge 822a rotates. Thus, when said second hinge 822b is moved by lifting said lid rack 118 with said upward direction 920, said first hinge 822a can be moved through a second path 950, as illustrated. Thus, said second support 804b can rotate like a lever around said second axis 942, as illustrated.

In one embodiment, said third axis 944 can comprise said first hinge 820a and can be fixed to said body 102. In one embodiment, said first support 802b can rotate around said third axis 944 as a lever. In one embodiment, said second hinge 820b can rotate at the far end of said first support 802b. Accordingly, since said second side portion 801b is attached to said second hinge 820b, a top surface 954 said front side 930 can be shifted according to a third path 952.

In one embodiment, said fourth axis 946 can comprise a center axis of said second side wheel 810b; wherein, said first side wheel 810a and said second side wheel 810b move in a fourth path 953, which can comprise a forward and a backward direction 922.

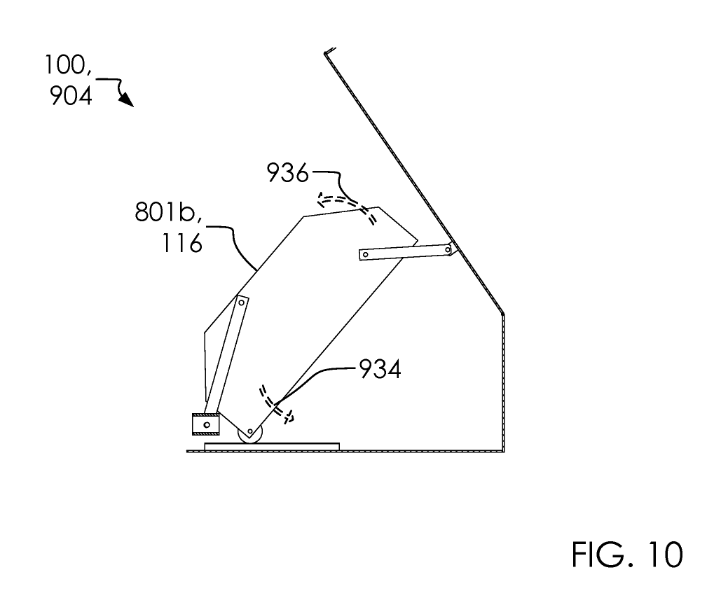

FIG. 10 illustrates an elevated front view said toolbox 100 in said second position 904.

In one embodiment, transitioning said toolbox 100 from said closed configuration 300 to said expanded configuration 101 can comprise: opening said lid 104 in an upward direction 920; pulling said one or more side wheels in said backward direction 922; rotating a front side 930 of said pivoting rack 116 in a down and back direction 934; rotating a back side 932 of said pivoting rack 116 in an up and forward direction 936.

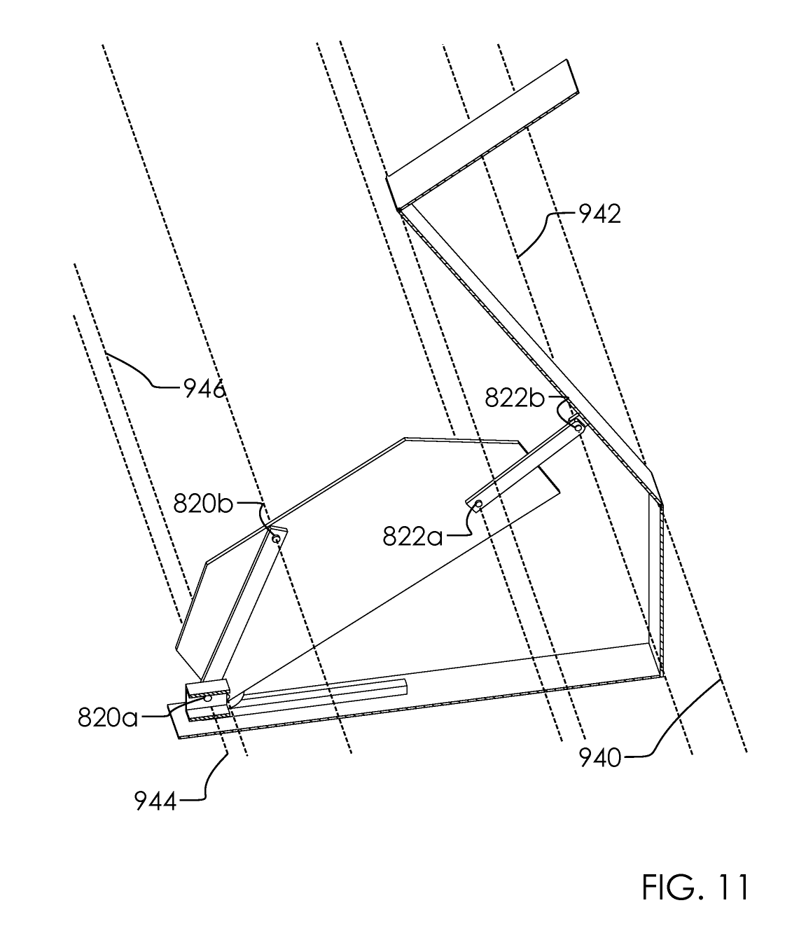

FIG. 11 illustrates a perspective overview of said toolbox 100 in said second position 904.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive.

For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A toolbox comprising:
said toolbox comprises a body, a one or more supports and a pivoting rack;
said body comprises a lid, a bottom plate, a faceplate, a back plate, a first side, a second side;
said toolbox is configured for selectively transitioning between an expanded configuration and a closed configuration;
said expanded configuration of said toolbox comprises an expanded height;
said body selectively opens and closes between said expanded configuration and said closed configuration;
with said toolbox in said closed configuration said body comprises a substantially rectangular shape and encases said tool box with
said first side and said second side on it sides,
said lid and a bottom plate at its top and bottom, and
said faceplate and a back plate at its front and back sides;
said lid selectively rotates on a first hinge relative to said back plate;
and said faceplate selectively rotates on a second hinge relative to said lid rack;
with said toolbox in said expanded configuration, said one or more supports a portion of said toolbox;
with said toolbox in said closed configuration said faceplate selectively rotates on said second hinge to provide access within said toolbox;
a portion of said body wraps around said pivoting rack including said bottom plate which is attached to said back plate, said lid which is rotateably attached to said back plate, and said faceplate which is rotateably attached to said lid;
said one or more supports comprise a first support and a second support;
said bottom plate of said toolbox comprises a one or more tracks; and
said one or more tracks are arranged as perpendicular with said faceplate with said toolbox in said closed configuration.

2. A toolbox comprising:
said toolbox comprises a body, a one or more supports and a pivoting rack;
said body comprises a lid, a bottom plate, a faceplate, a back plate, a first side, a second side;
said toolbox is configured for selectively transitioning between an expanded configuration and a closed configuration;
said expanded configuration of said toolbox comprises an expanded height;
said body selectively opens and closes between said expanded configuration and said closed configuration;
with said toolbox in said closed configuration said body comprises a substantially rectangular shape and encases said tool box with
said first side and said second side on it sides,
said lid and a bottom plate at its top and bottom, and
said faceplate and a back plate at its front and back sides;
said lid selectively rotates on a first hinge relative to said back plate;
and said faceplate selectively rotates on a second hinge relative to said lid rack;
with said toolbox in said expanded configuration, said one or more supports a portion of said toolbox;
with said toolbox in said closed configuration said faceplate selectively rotates on said second hinge to provide access within said toolbox;
a portion of said body wraps around said pivoting rack including said bottom plate which is attached to said back plate, said lid which is rotateably attached to said back plate, and said faceplate which is rotateably attached to said lid.

3. The toolbox of claim 2 further comprising:
said one or more supports comprise a first support and a second support.

4. The toolbox of claim 2 further comprising:
said bottom plate of said toolbox comprises a one or more tracks; and
said one or more tracks are arranged as perpendicular with said faceplate with said toolbox in said closed configuration.

5. The toolbox of claim 4 further comprising:
said drawer rides on said one or more tracks.

6. The toolbox of claim 2 further comprising:
said first side first sidend said second side can comprise pneumatic cylinders.

7. The toolbox of claim 2 further comprising:
said body further comprises a one or more handles.

8. The toolbox of claim 2 further comprising:
said toolbox further comprises a lower tray.

9. The toolbox of claim 2 further comprising:
said toolbox further comprises a drawer.

10. The toolbox of claim 2 further comprising:
said toolbox further comprises a lid rack.

11. The toolbox of claim 2 further comprising:
said toolbox comprises a latching system which comprises a latch and a strike plate; and
further, said latching system comprises a locking mechanism.

12. The toolbox of claim 2 further comprising:
said collapsed configuration allows for access to tools within said toolbox; and
said faceplate opens with said toolbox in said collapsed configuration which allows a drawer to be rolled out and accessed with said toolbox in a low profile.

13. The toolbox of claim 2 further comprising:
said body is constructed to withstand heavy weights on top of said lid.

14. The toolbox of claim 2 further comprising:
said pivoting rack comprises a one or more pegs and/or a one or more slots which are configured to selectively hold a one or more tools.

15. The toolbox of claim 2 further comprising:
said toolbox further comprises a drawer;
said drawer comprises a one or more runners;
said one or more runners releaseably attach to a one or more tracks within said body; and
said drawer is configured to selectively move relative to said bottom plate on said one or more tracks.

16. The toolbox of claim 2 further comprising:
said pivoting rack comprises a first side portion (not illustrated) and a second side portion;
said second side portion comprises a substantially vertical planar surface attached to said body with a first support and said lid with a second support, as discussed to follow; and
said first side portion be attached to said lid with a second support and said body with a first support.

17. The toolbox of claim 16 further comprising:
said toolbox further comprise a one or more outer supports which comprises an outer support (not illustrated) and an outer support; and
said one or more outer supports attach to said pivoting rack to said first side and said second side.

18. The toolbox of claim 2 further comprising:
first support comprises a first end and a second end;
said first end rotateably attach to said outer support with a first hinge;
said second end rotateably attach to said second side portion with a second hinge;
said second support comprises a first end and a second end;
said first end rotateably attach to said second side portion with a first hinge;
said lid comprises a lid support, which comprises a substantially vertical element suspended from and attached to said lid being substantially parallel with said second support; and
said second end rotateably attach to said lid support of said lid with a second hinge.

19. The toolbox of claim 2 further comprising:
said pivoting rack move horizontally on a one or more side tracks on said bottom plate, which comprises a first side track (not illustrated) and a second side track;
said pivoting rack comprises a one or more side wheels, which comprises a first side wheel (not illustrated) and a second side wheel;
said first side wheel roll on said first side track, and said second side wheel roll on said second side track; and
said first side wheel and said second side wheel roll on said one or more side tracks, as illustrated and as is known in the art.

20. The toolbox of claim 2 further comprising:
said pivoting rack move according to a four axes comprising a first axis, a second axis, a third axis a fourth axis;
said first axis comprises said first hinge and comprises an axis about which said second hinge rotates; and
Thus, by lifting said lid rack in said upward direction, said second hinge rotate about said first axis in a first path.
